(19) United States
(12) Patent Application Publication
(10) Pub. No.: US 2006/0219822 A1
(43) Pub. Date: Oct. 5, 2006

(54) Dual volume shower head system

(75) Inventors: Michael A. Miller, Portage, MI (US); Mordechai Lev, West Bloomfield, MI (US); Jon Voel, Croscent Springs, KY (US)

Correspondence Address: CARLSON, GASKEY & OLDS, P.C., 400 WEST MAPLE ROAD, SUITE 350, BIRMINGHAM, MI, 48009, US

(73) Assignee: Alsons Corporation

(21) Appl. No.: 11/375,913

(22) Filed: Mar. 15, 2006

Related U.S. Application Data
(60) Provisional application No. 60/662,837, filed on Mar. 17, 2005.

(51) Int. Cl. A62C 37/20

(52) U.S. Cl. 239/562; 239/581.1; 239/587.4

(57) ABSTRACT

A dual volume shower head assembly utilizes two flow control regulators to provide specific flow rates. A flow control diverts fluid flow around a low flow limiter such that an upstream high flow limiter provides the restriction. The limiters may provide any desired flow rate by simply snapping a limiter of a desired rate into the mount locations.

The present application claims priority to U.S. Provisional Patent Application Ser. No. 60/662,837, filed 17 Mar. 2005.

### BACKGROUND OF THE INVENTION

The present invention relates to a shower head assembly, and more particularly to a shower head which will selectively adjust a flow rate by actuating a control within the shower head.

To reduce water consumption in many parts of the world, various devices for limiting water delivery on plumbing products are being developed and even mandated. Local and regional code agencies are specifying permissible water flow volumes in gallons per minute (gpm) on faucet aerators and shower heads. The maximum water flow presently permitted under most of these codes is often in the range of 2.0 to 2.5 gpm.

Standard shower head assemblies often have an adjustment ring that can be turned to vary the type and amount of water flow from the shower head. The ring can vary the volume of water flowing through the shower head and can switch the shower head between different spray modes. These designs may be bulky and complex in that they require a variety of parts that increase the cost of the shower head.

Additionally, standard shower head volume control mechanisms that rely on restricting flow of water by reducing the orifice size of the water path may not consistently achieve a specific flow rate over a range of water pressures.

Accordingly, it is desirable to provide an uncomplicated shower head with a volume control mechanisms that readily achieves a multitude of specific flow rates over a range of water pressures.

### SUMMARY OF THE INVENTION

A dual volume shower head assembly according to the present invention utilizes two flow limiters to provide specific flow rates. A flow control selectively diverts fluid flow around a low flow limiter such that an upstream high flow limiter provides the restriction.

In operation, the high flow limiter within a ball connector and the low flow limiter within a downstream regulator plate define the flow rates. The limiters may provide any desired flow rate by locating a limiter of a desired rate into the mount locations.

When a low flow rate is desired, a knob is positioned such that a valve of the flow control seals an opening such that the flow of water to a flow engine is limited by the low flow limiter as the only water flow path is through the low flow limiter. When a high flow rate is desired, the knob is positioned such that the valve is lifted from the opening to permit water flow therethrough. The flow of water to the flow engine is thereby limited only by the high flow limiter since the combined flow through both the downstream low flow limiter and opening is greater than the high flow limiter. The high flow limiter thereby provides the only restriction on the water flow prior to the flow engine.

The present invention therefore provides an uncomplicated shower head with a volume control mechanisms that readily achieves a multitude of specific flow rates over a range of water pressures.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a perspective view of a shower head assembly according to the present invention;

FIG. 2 is an exploded view of the shower head assembly;

FIG. 3A is a longitudinal sectional view of the shower head taken parallel to a cam shaft;

FIG. 3B is a longitudinal sectional view taken perpendicular to the cam shaft;

FIG. 3C is a perspective sectional view taken across the cam shaft and flow control interface;

FIG. 4 is a side view of the flow control;

FIG. 5 is a perspective view of the knob;

FIG. 6A is a perspective view of the cam shaft;

FIG. 6B is a longitudinal sectional view of the cam shaft;

FIG. 6C is a sectional view of the cam shaft taken laterally through the cam;

FIG. 7 is a perspective view of a regulator plate;

FIG. 8A is a sectional view of the shower head in a low flow position; and

FIG. 8B is a sectional view of the shower head in a high flow position.

### DETAILED DESCRIPTION OF THE PREFERRED EMBODIMENT

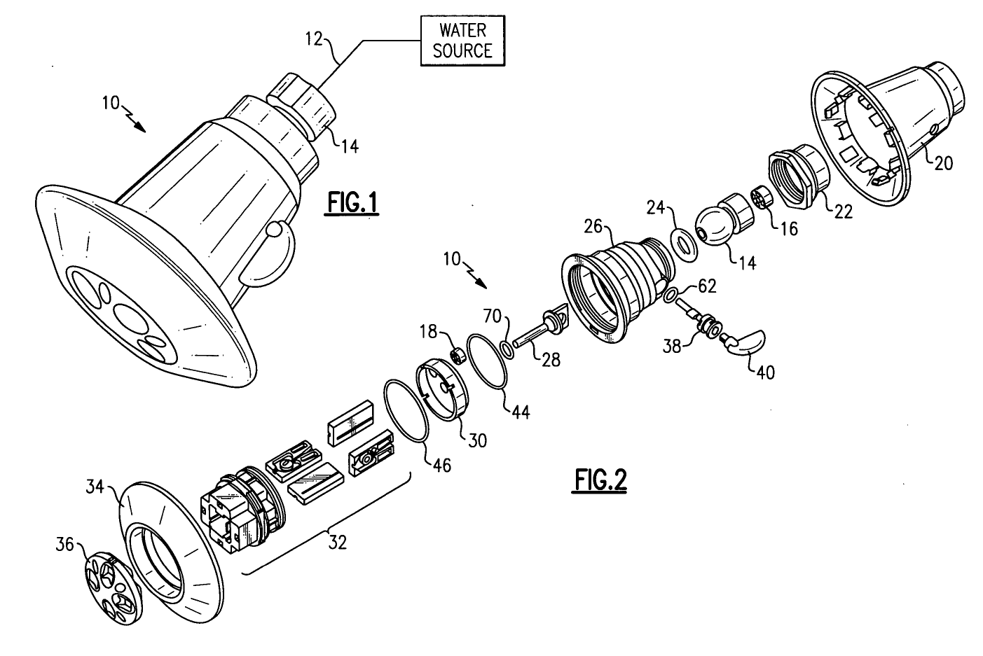

FIG. 1 illustrates a general perspective view of a dual volume control shower head assembly 10. The shower head assembly 10 is connected to a water source (shown schematically) by a water input line 12. The shower head assembly 10 may be connected to the water input line 12 by a ball connector 14. The ball connector 14 allows the shower head 10 to be manipulated through a variety of positions. It should be understood that the shower head 10 may be permanently attached to a shower wall or may be of the hand held type that can be removed from the shower wall. Also, other types of connections between the water input line 12 and the shower head 10 can be employed.

Referring to FIG. 2, the shower head 10 is illustrated in an exploded view. The shower head 10 generally includes, the ball connector 14, a high flow limiter 16, a low flow limiter 18, a shell 20, a collar 22, a ball seal 24, an inner housing 26, a flow control 28, a regulator plate 30, a flow engine 32, a crown 34, a spray face 36, a cam shaft 38 and a knob 40. The components are preferably constructed of a plastic material, but may be formed of other known materials.

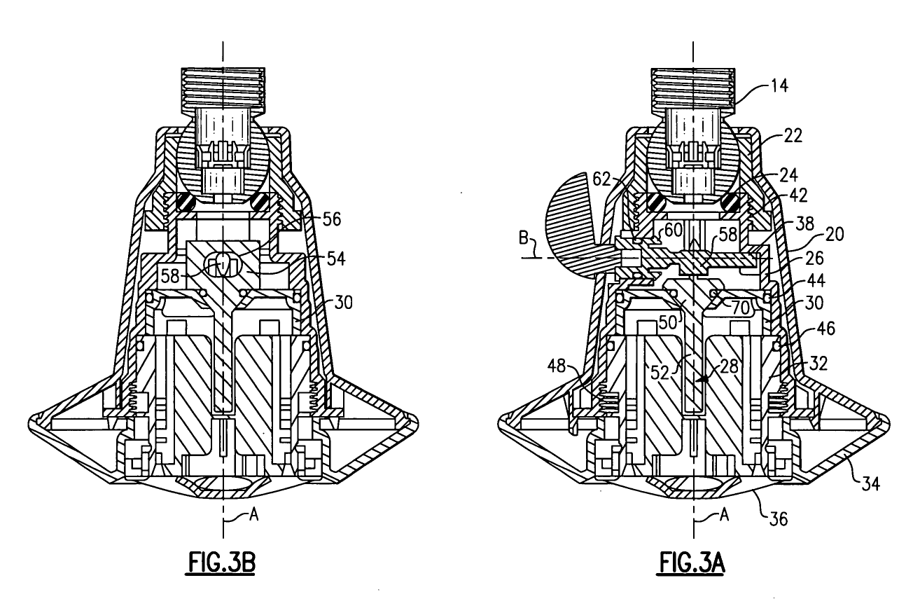

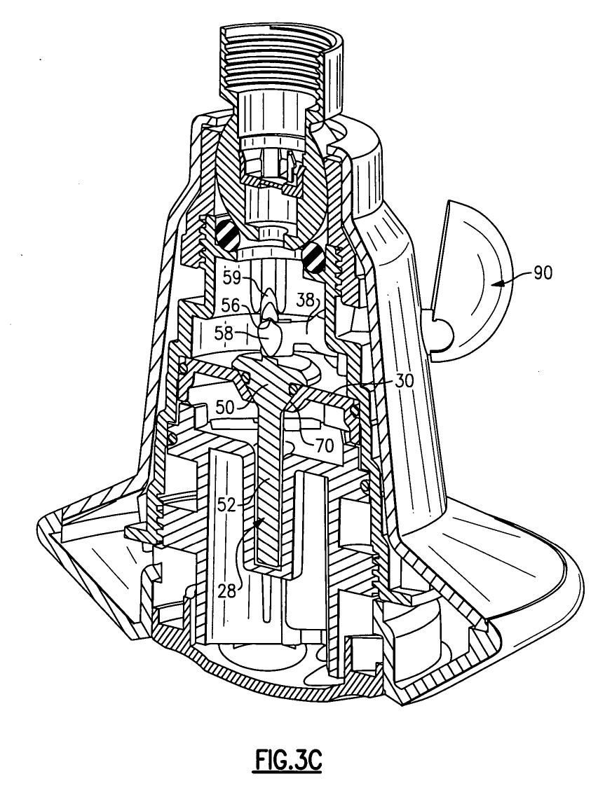

Referring to FIG. 3A, the ball connector 14 mounted within the collar 22 and interfaces with the inner housing 26 through the seal 24 such as an O-ring. The collar 22 is preferably threaded to the inner housing 26 at a threaded interface 42. The regulator plate 30 and the flow engine 32 are also mounted within the inner housing 26 and include respective seals 44, 46 such as O-ring seals.

The flow engine 32 is threaded to the inner housing 26 at a threaded interface 48 to retain the regulator plate 30 and flow control 28 therein. The flow engine preferably includes a multiple of fluidic washer nozzles which may be low-pressure, feedback passage-free fluidic oscillators which provide patternization, spray distribution across a fan angle, shape, and/or articulate a water spray. One such fluidic washer nozzle is manufactured by Bowles Fluidics Corporation of Columbia, Md., USA.

The shell 20, crown 34 and spray face 36 preferably snap over the inner housing 26 to provide an aesthetically pleasing outer surface. It should be understood that various construction arrangements utilizing various combinations of threaded interfaces, interference snap fits, as well as other attachments such as adhesives and the like may also be utilized with the present invention.

The flow control 28 includes a valve 50 mounted to a shaft 52 having a cam interface 54 (FIG. 4). The cam interface 54 includes an oval opening 56 which receives a cam 58 (FIG. 3B) which extends from the cam shaft 38 (also illustrated in FIG. 3C). The flow control 28 is mounted along a longitudinal axis A of the shower head 10 for axial movement there along in response to rotation of the cam shaft 38 (FIG. 6A) which is mounted traverse thereto along an axis of rotation B.

The cam shaft 38 preferably snaps into the inner housing 26 and is retained therein through barbs 60 (also illustrated in FIG. 6B) and sealed by a seal 62 such as an O-ring. It should be understood that various “snap” fit or interference based assemblies may be utilized with the present invention and barbs are but one example component which effectuates the illustrate assembly. The cam shaft 38 is located within the shell 20 while the knob 40 extends outward thereof. The knob 40 (FIG. 5) is mounted to the cam shaft 38 through barbs 64 to permit a snap fit which transmits rotation therethrough. That is, the knob 40 snaps into the cam shaft 38 along axis B and transmits rotation therethrough such that the cam shaft 38 is rotated thereby.

The cam 58 of the cam shaft 38 is generally airfoil shaped and is received within the oval opening 56. A ridge 66 on the cam 58 (FIG. 6C) selectively engages an indent 68 on the oval opening 56 (FIG. 4) to lock the shower head 10 the low flow position.

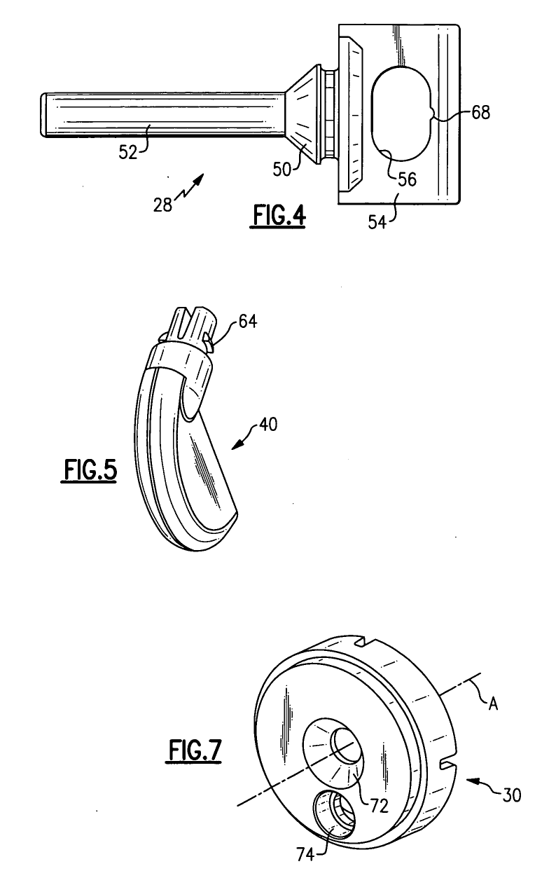

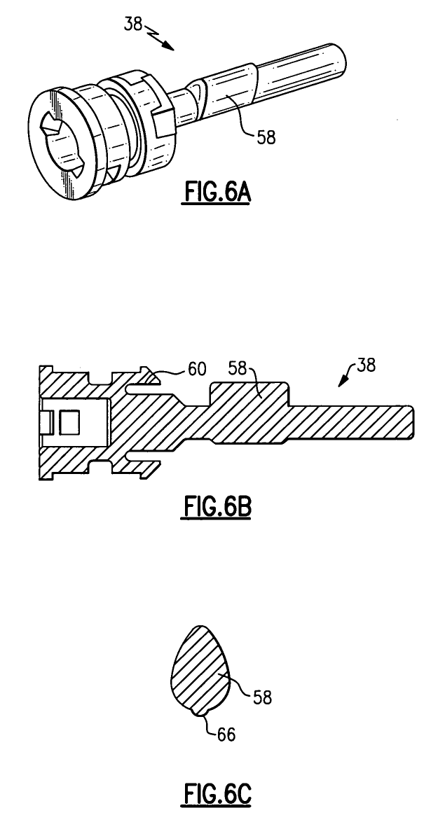

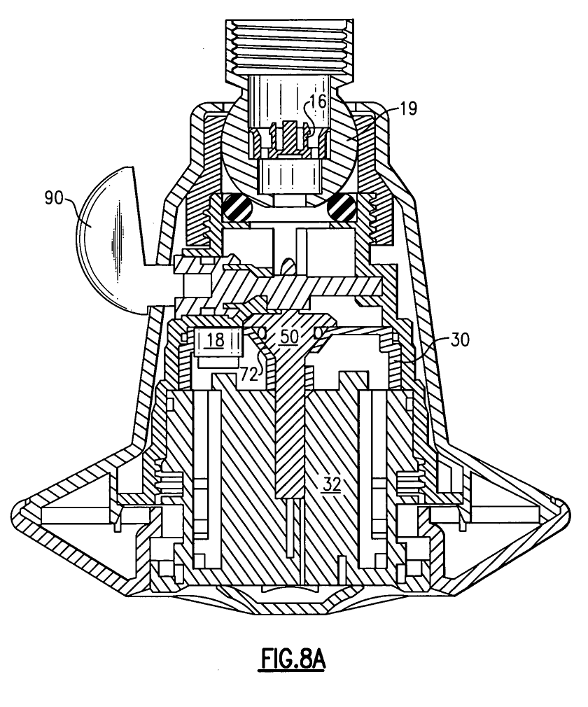

The valve 50 preferably includes a seal 70 such as an O-ring which selectively seals a first opening 72 mounted within the regulator plate 30 (FIG. 7). A second opening 74 in the regulator plate 30 (FIG. 7) receives the low flow limiter 18. It should be understood that the low flow limiter 18 may be friction fit into the second opening 74 such that replacement is readily achieved.

In operation, the high flow limiter 16 within the ball connector 14 and the low flow limiter 18 within the regulator plate 30 define the flow rates and may be easily changed to provide any desired combination of flow rates. That is, the high flow limiter 16 and the low flow limiter 18 may provide any desired flow rate by inserting the desired limiter into the mount locations in the ball connector 14 and/or regulator plate 30. In the illustrated embodiment, the limiters are rated at 2.5 GPM and 2.0 GPM, but may be rated for any desired flow rates.

The high flow limiter 16 is the higher rated flow control and is located in the ball connector 14 where the water flow is first introduced from the source 12 (FIG. 1). The low flow limiter 18—lower GPM than the high flow limiter 16—is located within the regulator plate 30 prior to the flow engine 32.

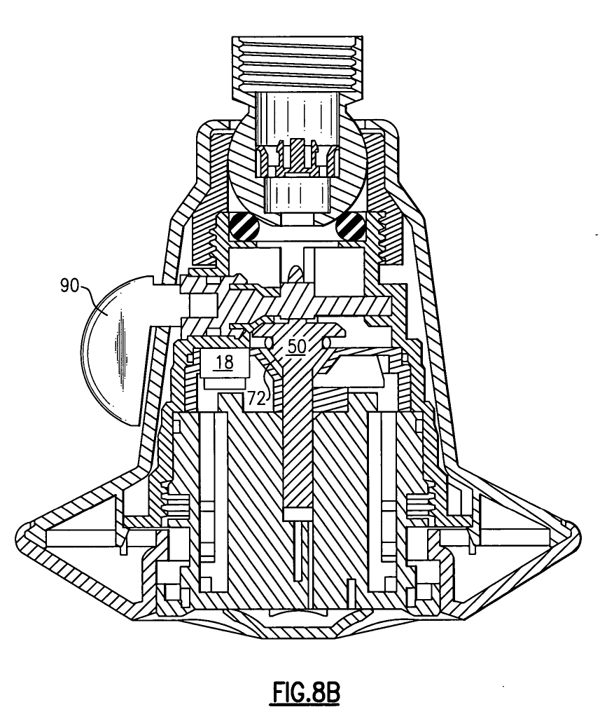

When the low flow rate is desired, the knob 40 is positioned such that the valve 50 seals the first opening 72. The flow of water to the flow engine is thereby limited by the low flow limiter 18 since the low flow limiter 18 provides a flow rate less than the high flow limiter 16 and the only water flow path is through the low flow limiter 18 (FIG. 8A).

When the high flow rate is desired, the knob 40 is positioned such that the valve 50 is lifted from the first opening 72 to permit water flow therethrough. The flow of water to the flow engine is thereby limited by the high flow limiter 16 since the water flow through the downstream low flow limiter 18 and open first opening 72 is at a rate greater than that provided by the high flow limiter 16. The high flow limiter 16 thereby provides the only restriction on the water flow prior to the flow engine 32 (FIG. 8B). That is, the high flow limiter 16 provides a greater restriction on the water flow than the combined opening provided by the first opening 72 and the low flow limiter 18.

It should be understood that relative positional terms such as “forward,” “aft,” “upper,” “lower,” “above,” “below,” and the like are with reference to the normal operational attitude of the vehicle and should not be considered otherwise limiting.

It should be understood that although a particular component arrangement is disclosed in the illustrated embodiment, other arrangements will benefit from the instant invention.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A volume control shower head assembly comprising:
a high flow limiter;
a regulator plate having an opening;
a low flow limiter downstream of said high flow limiter;
a flow control mounted within said opening along a first axis;
a cam shaft transverse to said first axis, said cam shaft movable to move said flow control between a first position engaged with said opening to provide a first flow volume defined by said low flow limiter and a second position disengaged from said first opening to provide a second flow volume defined by said high flow limiter.

2. The assembly as recited in claim 1, wherein said second volume is greater than said first volume.

3. The assembly as recited in claim 1, wherein said flow control is axial movable along said first axis.

4. The assembly as recited in claim 1, wherein said cam shaft extends through said flow control.

5. The assembly as recited in claim 1, wherein said high flow limiter is mounted within a connector.

6. The assembly as recited in claim 1, wherein said low flow limiter is mounted within said regulator plate.

7. The assembly as recited in claim 1, wherein said high flow limiter and said low flow limiter are replaceable.

8. The assembly as recited in claim 1, further comprising a flow engine downstream of said regulator plate to define a spray pattern.

9. A volume control shower head assembly comprising:
a ball connector;
a high flow limiter mounted within said ball connector;
a regulator plate having an opening and a low flow limiter, said regulator plate downstream of said high flow limiter;
a flow control mounted within said opening along a first axis;
a cam shaft transverse to said first axis, said cam shaft movable to move said flow control between a first position engaged with said opening to provide a first flow volume defined by said low flow limiter and a second position disengaged from said first opening to provide a second flow volume defined by said high flow limiter; and
a flow engine mounted downstream of said regulator plate to define a spray pattern.

10. The assembly as recited in claim 9, wherein said flow control includes a valve mounted to a shaft, said valve engageable with said opening.

11. The assembly as recited in claim 10, wherein said opening defines a frustro-conical opening.

12. The assembly as recited in claim 9, wherein said cam shaft extends through said flow control upstream of said valve.

13. The assembly as recited in claim 12, further comprising an airfoil-shaped member mounted along said cam shaft, said airfoil-shaped member engageable with an oval-shaped opening formed in said flow control.

14. A method of volume control for a dual volume shower head assembly comprising the steps of:
(A) communicating a fluid through a high flow limiter to provide a first fluid flow volume defined by the high flow limiter;
(B) communicating the fluid through a low flow limiter after said step (A) to restrict the first flow volume to a second fluid flow volume less than the first fluid flow volume; and
(C) selectively communicating the first fluid flow through both the low flow limiter and an opening to provide the first fluid flow volume as defined by the high flow limiter.

15. A method as recited in claim 14, wherein said step (C) further comprises:
(a) sealing the opening with a flow control.

16. A method as recited in claim 15, wherein said step (C) further comprises:
(b) locating the opening in a regulator plate which retains the low flow limiter.

17. A method as recited in claim 16, further comprising the step of:
(D) communicating the fluid through a flow engine downstream of the regulator plate.

18. A method as recited in claim 16, wherein said step (D) further comprises:
(a) defining a spray pattern with the flow engine.

19. A method as recited in claim 14, wherein said step (A) further comprises:
(a) locating the high flow limiter within a ball connector connected to a fluid source.

20. A method as recited in claim 14, wherein said step (C) further comprises:
(B) rotating a cam shaft to axially drive a flow control to a position to close the opening.
